(19) United States
(12) Patent Application Publication
(10) Pub. No.: US 2018/0264810 A1
(43) Pub. Date: Sep. 20, 2018

(54) INK JET HEAD AND INK JET RECORDING APPARATUS

(71) Applicant: TOSHIBA TEC KABUSHIKI KAISHA, Tokyo (JP)

(72) Inventor: Sota HARADA, Mishima Shizuoka (JP)

(21) Appl. No.: 15/916,324

(22) Filed: Mar. 9, 2018

(30) Foreign Application Priority Data
Mar. 14, 2017 (JP) 2017-049029

(51) Int. Cl. B41J 2/045

(52) U.S. Cl. CPC B41J 2/04595; B41J 2/04581; B41J 2/04541

(57) ABSTRACT

According to one embodiment, an ink jet head includes an actuator configured to cause ink to be discharged from a pressure chamber associated with the actuator, and a control unit configured to apply to the actuator in a droplet ejection process an auxiliary signal that does not cause ink to be discharged from the pressure chamber, and a discharge signal that causes ink to be discharged from the pressure chamber.

### CROSS-REFERENCE TO RELATED APPLICATION

This application is based upon and claims the benefit of priority from Japanese Patent Application No. 2017-049029, filed Mar. 14, 2017, the entire contents of which are incorporated herein by reference.

### FIELD

Embodiments described herein relate generally to an ink jet head and an ink jet recording apparatus.

### BACKGROUND

An inkjet head of an image forming apparatus discharges ink by expanding and then releasing an ink chamber. Such an ink jet head continuously discharges ink droplets at a high speed so as to print an image.

The ink jet head discharges ink using a pressure vibration generated in the ink chamber. However, before discharge, the ink chamber and an actuator are not stable.

Therefore, there is a case where an existing ink jet head cannot always stably discharge ink for low gradation printing, and printing quality will be deteriorated.

### DESCRIPTION OF THE DRAWINGS

FIG. 1 is a perspective view of an ink jet printer according to an embodiment.

FIG. 2 is an enlarged perspective view of an ink jet head.

FIG. 3 is a cross-sectional view of an ink jet head.

FIG. 4 is a longitudinal section view of an inkjet head.

FIG. 5 is a block diagram of a head drive circuit.

FIGS. 6A, 6B, and 6C depict operation examples of an ink jet head.

FIG. 7 is a timing chart for a pulse applied to an actuator according to an embodiment.

FIG. 8 is another timing chart for a pulse applied to an actuator according to an embodiment.

### DETAILED DESCRIPTION

According to an embodiment, an ink jet head includes an actuator configured to cause ink to be discharged from a pressure chamber associated with the actuator, and a control unit configured to apply to the actuator in a droplet ejection process an auxiliary signal that does not cause ink to be discharged from the pressure chamber, and a discharge signal that causes ink to be discharged from the pressure chamber.

Hereinafter, an ink jet printer (also referred to as an inkjet recording apparatus) according to example embodiments will be described with reference to the drawings. It should be noted that the particular embodiments explained below are some possible example of an image forming apparatus according to the present disclosure and do not limit the possible configuration, specifications, or the like of image forming apparatuses according to the present disclosure.

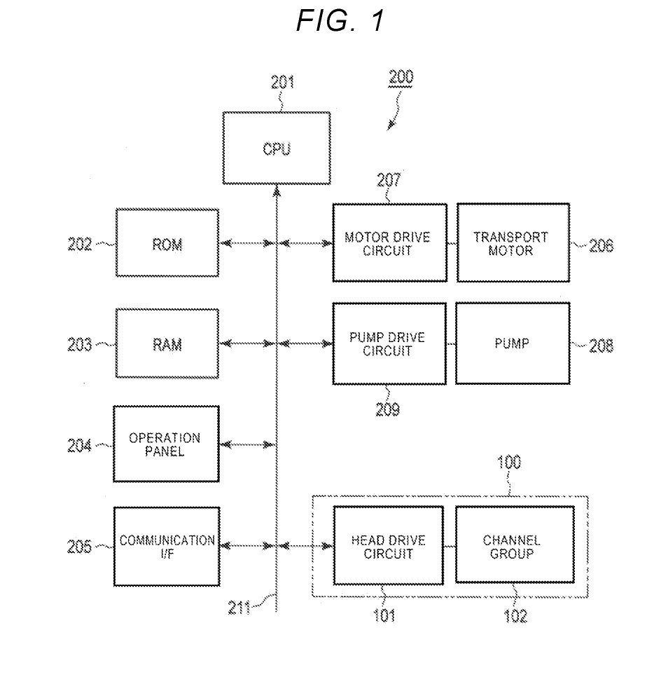

FIG. 1 is a perspective view of an ink jet printer 200 (hereinafter, abbreviated as printer 200). The printer 200 is, for example, an office printer, a bar code printer, a POS printer, an industrial printer, and the like.

The printer 200 includes a central processing unit (CPU) 201, a read only memory (ROM) 202, a random access memory (RAM) 203, an operation panel 204, a communication interface 205, a transport motor (206, a motor drive circuit 207, a pump 208, a pump drive circuit 209, and an inkjet head 100. In addition, the printer 200 includes a bus line 211 such as an address bus and a data bus. Further, in the printer 200, the CPU 201, the ROM 202, the RAM 203, the operation panel 204, the communication interface 205, the motor drive circuit 207, the pump drive circuit 209, and a head drive circuit 101 of the ink jet head 100 are connected to the bus line 211 directly or via an I/O circuit.

The CPU 201 corresponds to a central part of a computer. The CPU 201 controls the respective units so as to realize various functions as the printer 200 according to an operating system or an application program.

The ROM 202 corresponds to a main memory part of the computer. The ROM 202 stores the operating system and the application program. The ROM 202 stores data which is required when the CPU 201 performs a process of controlling the respective units in some cases.

The RAM 203 corresponds to the main memory part of the computer. The RAM 203 stores data required when the CPU 201 performs a process. In addition, the RAM 203 is used as a work area in which information is appropriately re-written by the CPU 201. The work area includes an image memory in which print data is developed.

The operation panel 204 includes an operation unit and a display unit. In the operation unit, function keys such as a power key, a paper feed key, and an error release key are disposed. The display unit can display various states of the printer 200.

The communication interface 205 receives print data from a client terminal connected via network such as a local area network (LAN). The communication interface 205 transmits a signal that notifies an error, for example, when an error occurs in the printer 200 to the client terminal.

The motor drive circuit 207 controls driving of the transport motor 206. The transport motor 206 functions as a drive source of a transport mechanism that transports a recording medium such as a printing paper. When the transport motor 206 is driven, the transport mechanism starts the transporting of the recording medium. The transport mechanism transports the recording medium to a print position of the ink jet head 100. The transport mechanism extracts a recording medium on which the printing is completed to the outside of the printer 200 from a discharging port (not shown).

The pump drive circuit 209 controls the driving of the pump 208. When the pump 208 is driven, ink in an ink tank (not shown) is supplied to the ink jet head 100.

The head drive circuit 101 drives a channel group 102 of the ink jet head 100 based on the print data.

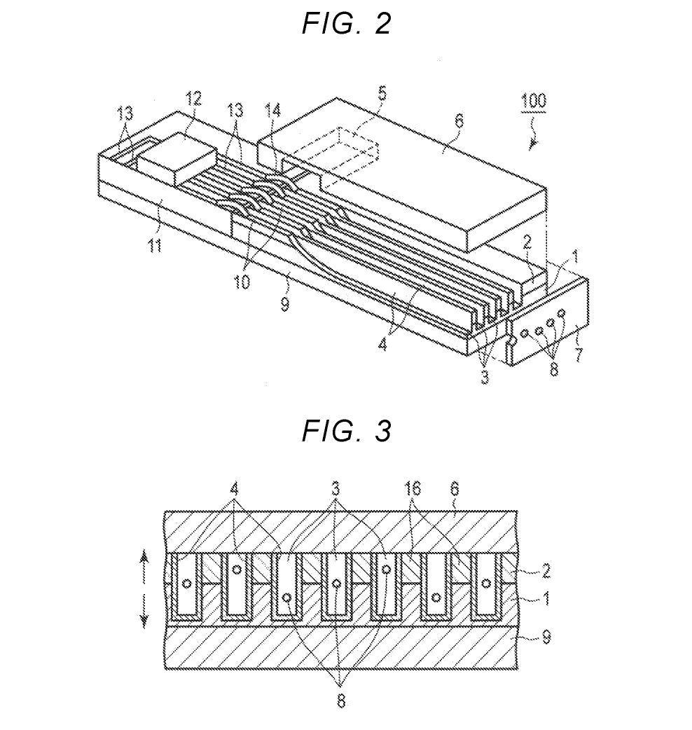

Hereinafter, the ink jet head according to the example embodiments will be described with reference to the drawings. In the example embodiments described herein, the ink jet head 100 is a shared mode type as depicted in FIG. 2. The ink jet head 100 will be described as a unit that discharges ink on paper. It should be noted that a printing medium on which the inkjet head 100 discharges ink is not limited to any specific configuration.

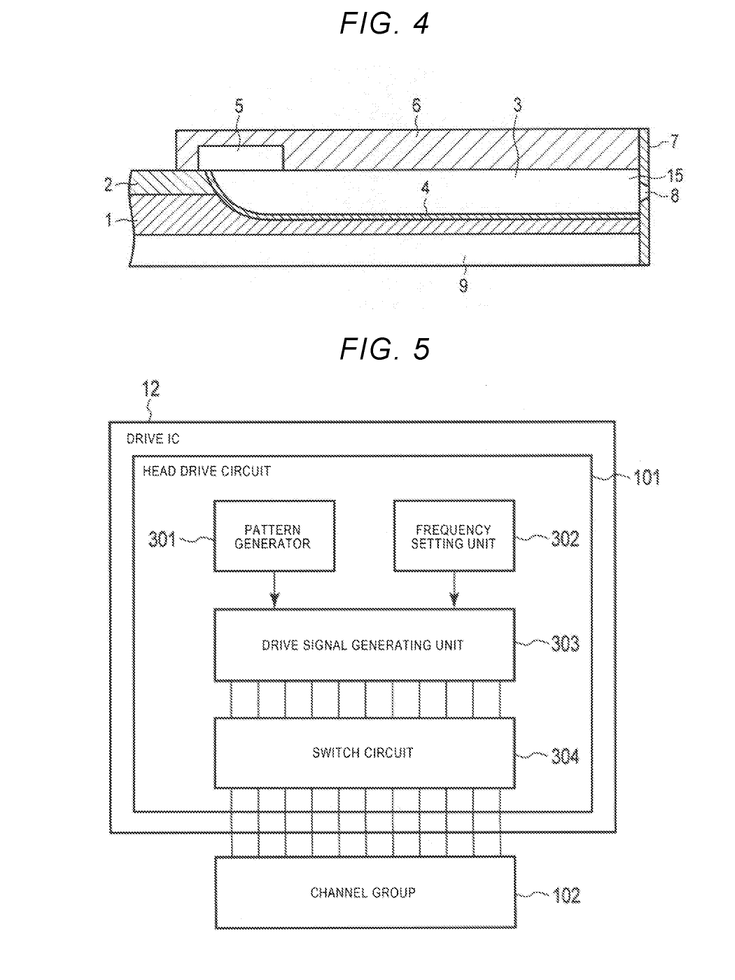

Next, the ink jet head 100 will be described with reference to FIG. 2 to FIG. 4. FIG. 2 is an enlarged perspective view of the inkjet head 100. FIG. 3 is a cross-sectional view of the inkjet head 100. FIG. 4 is a longitudinal section view of the ink jet head 100.

The ink jet head 100 includes a base substrate 9. In the ink jet head 100, a first piezoelectric member 1 is joined on an upper surface of on the front side of the base substrate 9, and a second piezoelectric member 2 is joined on the first piezoelectric member 1. As indicated by the arrow in FIG. 3, the joined first piezoelectric member 1 and second piezoelectric member 2 are polarized in mutually opposite directions along the plate thickness direction.

The base substrate 9 is formed of a material which has small dielectric constant, and a small difference in thermal expansion coefficient from the first piezoelectric member 1 and the second piezoelectric member 2. Example materials for the base substrate 9 include alumina (Al₂O₃), silicon nitride (Si₃N₄), silicon carbide (SiC), aluminum nitride (AlN), and lead zirconate titanate (PZT). Example materials for the first piezoelectric member 1 and the second piezoelectric member 2 include lead zirconate titanate (PZT), lithium niobate (LiNbO₃), and lithium tantalate (LiTaO₃).

In the ink jet head 100, a number of elongated grooves 3 are provided from the front end side to the rear end side of the joined first piezoelectric member 1 and second piezoelectric member 2. The grooves 3 are provided at a regular interval, and are parallel with each other. In each of the grooves 3, the front end opens and the rear end tilts upward.

In the ink jet head 100, an electrode 4 is provided on a side wall and a bottom of each of the grooves 3. The electrode 4 has a two-layer structure of nickel (Ni) and gold (Au). The electrode 4 is formed uniformly in each groove 3 by, for example, a plating method. The method of forming the electrode 4 is not limited to the plating method. For example, a sputtering method and a vapor deposition method can be used as well.

In the ink jet head 100, an extraction electrode 10 is provided from the rear end of each of the grooves 3 to an upper surface of the rear portion of the second piezoelectric member 2. The extraction electrode 10 extends from the electrode 4.

The inkjet head 100 includes a top board 6 and an orifice plate 7. The top board 6 blocks the upper portions of the grooves 3. The orifice plate 7 blocks the front ends of the respective grooves 3. The ink jet head 100 forms a plurality of pressure chambers 15 surrounded by the respective grooves 3, the top board 6, and the orifice plate 7. The pressure chambers 15 are formed into a shape having a depth of 300 μm and a width of 80 μm, and arranged in parallel at a pitch of 169 μm. Such a pressure chamber 15 is also referred to as an ink chamber.

The top board 6 includes a common ink chamber 5 on the inner rear side thereof. On the orifice plate 7, a nozzle 8 is bored at a position facing each of the grooves 3. The nozzle 8 communicates with the opposed groove 3, that is, the pressure chamber 15. The nozzle 8 has a tapered shape from the pressure chamber 15 side toward the opposite ink discharge side. The nozzles 8 corresponding to three pressure chambers 15 which are adjacent to each other are set as one set, and are formed to be shifted at a constant interval in the height direction of the groove 3 parallel to the vertical direction on the paper of FIG. 3.

The piezoelectric member partitioning the pressure chamber 15 is sandwiched between the electrodes 4 provided in the pressure chambers 15 so as to form an actuator 16.

In the ink jet head 100, a printed board 11 on which a conductive pattern 13 is formed is connected on the upper surface on the rear side of the base substrate 9. In the ink jet head 100, a drive IC 12 to which the head drive circuit 101 (control unit) is mounted is installed on the printed board 11. The drive IC 12 is connected to the conductive pattern 13. The conductive pattern 13 is connected to each extraction electrode 10 by a conducting wire 14 by wire bonding.

A set of the pressure chamber 15, the electrode 4, and the nozzle 8 which are included in the ink jet head 100 is referred to as a channel. That is, the ink jet head 100 includes N channels (ch.1 through ch.N) when the number of the grooves 3 is N.

FIG. 5 is a block diagram of the head drive circuit 101. As described above, the head drive circuit 101 is disposed in the drive IC 12.

The head drive circuit 101 drives a channel group (ch.1 through ch.N) 102 of the ink jet head 100 based on print data.

The channel group 102 is a channel including the pressure chamber 15, the electrode 4, the nozzle 8, and the like. That is, the channel group 102 discharges ink by an operation of the pressure chambers 15 in which the actuator 16 expands and contracts based on a control signal from the head drive circuit 101.

As described in FIG. 5, the head drive circuit 101 includes a pattern generator 301, a frequency setting unit 302, a drive signal generating unit 303, a switch circuit 304, and the like.

The pattern generator 301 generates various wave patterns including an expansion pulse signal (“Dump”), which expands the volume of the pressure chamber 15, a pause time (“Release”) during which the volume of the pressure chamber 15 is released (that is, permitted to return towards a relaxed state), and then a wave pattern of a contraction pulse signal which contracts the volume of the pressure chamber 15.

The pattern generator 301 generates a wave pattern of a discharge pulse signal (also referred to as a discharge signal) that causes one ink droplet to be discharged. The discharge pulse signal is formed of an expansion pulse signal and then a pause (Release) in sequence. The sum of the times for the expansion pulse and the pause time is a cycle time for discharging one ink droplet. This cycle is referred to as a one drop cycle.

In addition, the pattern generator 301 generates a wave pattern of an auxiliary pulse signal (Boost) (also referred to as an auxiliary signal) that does not cause an ink droplet to be discharged. The pattern generator 301 generates a wave pattern including two auxiliary pulse signals, that is, a first auxiliary pulse signal and a second auxiliary pulse signal.

The first auxiliary pulse signal is formed of the contraction pulse signal. The second auxiliary pulse signal is formed of the expansion pulse signal.

Further, the pattern generator 301 generates a wave pattern including a cancel pulse signal, which suppresses the pressure vibration. The cancel pulse signal is formed of an expansion pulse or a contraction pulse.

The frequency setting unit 302 sets a drive frequency of the ink jet head 100. The drive frequency is the frequency of the drive pulse generated by the drive signal generating unit 303. The head drive circuit 101 operates according to the driving pulse.

In accordance with print data input from the bus line, the drive signal generating unit 303 generates a pulse signal for each channel based on the wave pattern generated by the pattern generator 301 and the drive frequency set by the frequency setting unit 302. The pulse signal for each channel is output from the drive signal generating unit 303 to the switch circuit 304.

The switch circuit 304 switches a voltage applied to the electrode 4 of each channel in response to the pulse signal for each channel. That is, the switch circuit 304 applies a voltage to the actuator 16 for each channel based on an energization time (that is, the time at high voltage level) for the expansion pulse signal set by the pattern generator 301.

When the switch circuit 304 switches the voltage, the volume of the pressure chamber 15 of each channel is expanded or contracted so as to discharge ink droplets according to the number of gradations intended for the nozzle 8 of each channel.

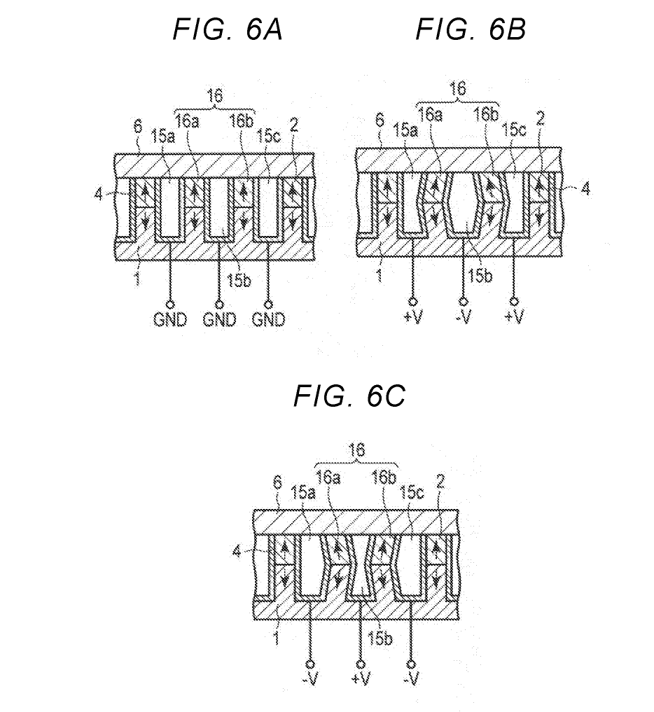

FIG. 6A illustrates a state of the pressure chamber 15b during the pause. As illustrated in FIG. 6A, the head drive circuit 101 sets the potentials of the electrodes 4 on the wall surfaces of the pressure chamber 15b and the pressure chambers 15a and 15c which are adjacent to the pressure chamber 15b to a ground potential GND. In this state, distortion does not occur in any of a partition 16a sandwiched between the pressure chamber 15a and the pressure chamber 15b, and a partition 16b sandwiched between the pressure chamber 15b and the pressure chamber 15c.

FIG. 6B illustrates an example of a state where the head drive circuit 101 applies the expansion pulse signal to the actuator 16 of the pressure chamber 15b. As illustrated in FIG. 6B, the head drive circuit 101 applies a negative voltage −V to the electrode 4 of the central pressure chamber 15b, and applies a positive voltage +V to the electrodes 4 of the pressure chambers 15a and 15c which are adjacent to pressure chamber 15b. In this state, for each of the partitions 16a and 16b, an electric field that is twice the voltage V acts in a direction orthogonal to the polarization direction of the first piezoelectric member 1 and the second piezoelectric member 2. With such an action, each partition 16a and 16b is deformed outwardly so as to expand the volume of the pressure chamber 15b.

FIG. 6C illustrates an example of a state where the head drive circuit 101 applies the contraction pulse signal to the actuator 16 of the pressure chamber 15b. As illustrated in FIG. 6C, the head drive circuit 101 applies the positive voltage +V to the electrode 4 of the central pressure chamber 15b, and applies the negative voltage −V to the electrodes 4 of the pressure chambers 15a and 15c which are adjacent to the pressure chamber 15b. In this state, for each of the partitions 16a and 16b, an electric field twice the voltage V acts in the direction opposite to the state in FIG. 6B. With such an action, each partition 16a and 16b is deformed inwardly so as to contract the volume of the pressure chamber 15b.

When the volume of the pressure chamber 15b is expanded or contracted, the pressure vibration is generated in the pressure chamber 15b. With this pressure vibration, the pressure in the pressure chamber 15b is increased, and ink droplet is discharged from the nozzle 8 communicating with the pressure chamber 15b.

In this way, the partitions 16a and 16b separating the pressure chambers 15a, 15b and 15c serve as the actuator 16 for imparting the pressure vibration to the inside of the pressure chamber 15b with the partitions 16a and 16b as walls. That is, the pressure chamber 15 is contracted and expanded by the operation of the actuator 16.

In addition, each of the pressure chambers 15 shares the actuator 16 (partition wall) with the adjacent pressure chamber 15. For this reason, the head drive circuit 101 cannot individually drive each pressure chamber 15. The head drive circuit 101 divides the pressure chambers 15 into (n+1) groups at intervals of n (n is an integer of 2 or more) to drive the pressure chamber 15. In the example embodiment described herein, the head drive circuit 101 divides the pressure chambers 15 into sets of three at intervals of two pressure chambers so as to drive the pressure chambers 15. This driving is referred to as a three division drive and the three division drive is merely an example. The pressure chambers 15 may be divided into sets of four, sets of five, or the like.

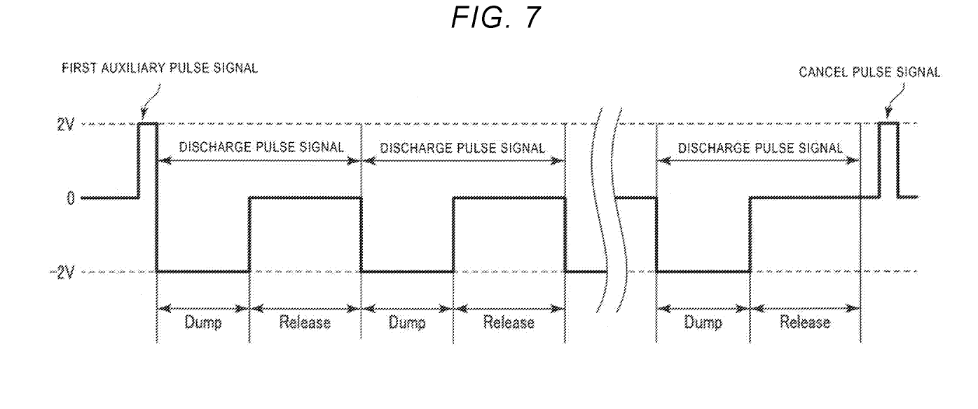

FIG. 7 is a timing chart illustrating an example signal applied by the head drive circuit 101 to the actuator 16 (partition 16a and 16b) of the pressure chamber 15. Here, the head drive circuit 101 is to continuously discharge ink droplets from the pressure chamber 15.

As illustrated in FIG. 7, the head drive circuit 101 applies a first auxiliary pulse signal, a discharge pulse signal, and a cancel pulse signal in series to the actuator 16 of the pressure chamber 15.

The first auxiliary pulse signal is formed in a rectangular shape having a predetermined width. That is, the first auxiliary pulse signal causes a constant voltage to be applied to the actuator 16 of the pressure chamber 15 for a duration corresponding to a pulse width of the first auxiliary pulse signal.

As described above, the first auxiliary pulse signal is the contraction pulse signal. That is, the first auxiliary pulse signal causes the pressure chamber 15 to be contracted when applied.

Further, the first auxiliary pulse signal is a signal which does not cause ink to be discharged from the pressure chamber 15. The first auxiliary pulse signal causes the pressure chamber 15 to be contracted during the time during which ink is not discharged from the pressure chamber 15. For example, the first auxiliary pulse signal is a contraction pulse signal having a width (time) equal to or less than ½ (acoustic length (AL)) of the fundamental pressure oscillation period of the pressure chamber 15. Here, a fundamental pressure oscillation period is a vibration cycle of the pressure vibration generated in the pressure chamber.

The first auxiliary pulse signal causes the pressure vibration to be generated in the pressure chamber 15. For example, the first auxiliary pulse signal causes the same pressure vibration as the pressure vibration generated in the pressure chamber 15 to be generated after discharging ink by the discharge pulse signal.

It should be noted that the configuration of the first auxiliary pulse signal is not limited to a specific configuration.

After the first auxiliary pulse signal is applied to the actuator 16, the head drive circuit 101 applies the discharge pulse signal to the actuator 16. The head drive circuit 101 may apply the discharge pulse signal at a predetermined time after an end of the first auxiliary pulse signal.

As described above, the discharge pulse signal is formed of the expansion pulse signal and the pause. That is, the discharge pulse signal expands and releases the pressure chamber 15.

During the application of the discharge pulse signal to the actuator 16, the pressure chamber 15 is first expanded to be a predetermined volume by the expansion pulse signal. The pressure chamber 15 is filled with ink inside by expansion. After a lapse of a predetermined time, the pressure chamber 15 is released. When the pressure chamber 15 is released, the volume of the pressure chamber 15 returns to the original state, and ink is discharged from the nozzle 8 communicating with the pressure chamber 15.

The head drive circuit 101 applies a plurality of discharge pulse signals to the actuator 16. That is, the head drive circuit 101 repeats a cycle of the expansion pulse signal and the pause. As a result, the head drive circuit 101 continuously discharges ink droplets from the pressure chamber 15.

After a predetermined number of discharge pulse signals is applied, the head drive circuit 101 applies the cancel pulse signal to the actuator 16. The head drive circuit 101 may apply cancel pulse signal at a predetermined time after an end of the discharge pulse signal.

The cancel pulse signal is a signal which does not cause ink to be discharged from the pressure chamber 15. For example, the cancel pulse signal suppresses the pressure vibration by the discharge pulse signal. Here, the cancel pulse signal is formed of the contraction pulse signal. The cancel pulse signal may be formed of the expansion pulse signal in some embodiments.

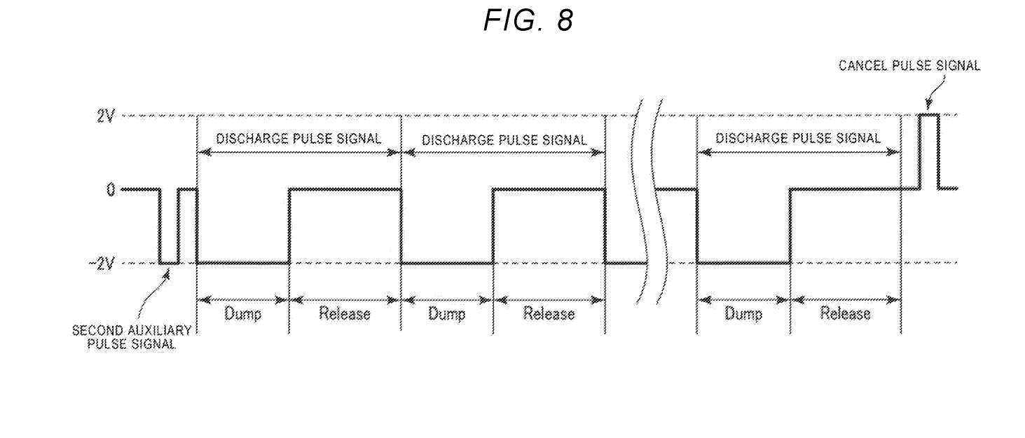

FIG. 8 is a timing chart illustrating another example signal applied by the head drive circuit 101 to the actuator 16 (partition 16a and 16b) of the pressure chamber 15. Here, the head drive circuit 101 is to continuously discharge ink droplets from the pressure chamber 15.

As illustrated in FIG. 8, the head drive circuit 101 applies a second auxiliary pulse signal, a discharge pulse signal, and a cancel pulse signal in series to the actuator 16 of the pressure chamber 15.

The second auxiliary pulse signal is formed in a rectangular shape having a predetermined width. That is, the second auxiliary pulse signal causes a constant voltage to be applied to the actuator 16 of the pressure chamber 15 for a duration corresponding to a pulse width of the second auxiliary pulse signal.

As described above, the second auxiliary pulse signal is the expansion pulse signal. That is, the second auxiliary pulse signal causes the pressure chamber 15 to be expanded when applied.

The second auxiliary pulse signal is a signal that does not cause ink to be discharged from the pressure chamber 15. The second auxiliary pulse signal causes the pressure chamber 15 to be expanded during a time during which ink is not discharged from the pressure chamber 15. For example, the first auxiliary pulse signal is a contraction pulse signal having a pulse width (time) equal to or less than AL.

The second auxiliary pulse signal causes a pressure vibration to be generated in the pressure chamber 15. For example, the second auxiliary pulse signal causes the same pressure vibration as is generated in the pressure chamber 15 after the discharging of ink with the discharge pulse signal.

It should be noted that the configuration of the second auxiliary pulse signal is not limited to a specific configuration.

When the second auxiliary pulse signal is applied to the actuator 16, the head drive circuit 101 applies a plurality of the discharge pulse signals after a lapse of a predetermined time. That is, the head drive circuit 101 repeats a cycle of the expansion pulse signal and the pause. As a result, the head drive circuit 101 continuously discharges ink droplets from the pressure chamber 15.

After a predetermined number of discharge pulse signals is applied, the head drive circuit 101 applies the cancel pulse signal to the actuator 16. The head drive circuit 101 may apply discharge pulse signal at a predetermined time after an end of the cancel pulse signal.

In cases of FIG. 7 and FIG. 8, the head drive circuit 101 may apply one discharge pulse signal to the actuator 16 after applying the first auxiliary pulse signal or the second auxiliary pulse signal. That is, the head drive circuit 101 may discharge one ink droplet from the pressure chamber 15.

Further, the head drive circuit 101 may not apply the cancel pulse signal. For example, the head drive circuit 101 may determine whether to apply the cancel pulse signal based on the pressure vibration (referred to as residual vibration) generated after applying the discharge pulse signal.

The head drive circuit 101 may determine whether to apply the first auxiliary pulse signal or the second auxiliary pulse signal based on the pressure vibration generated from the first auxiliary pulse signal and the pressure vibration generated from the second auxiliary pulse signal.

Further, the head drive circuit 101 may apply a plurality of auxiliary pulse signals.

The head drive circuit 101 may apply the first auxiliary pulse signal having a voltage that is close to 0 V and lower than the voltage of the contraction pulse signal. That is, the first auxiliary pulse signal may not cause the pressure chamber to be contracted as compared with the contraction pulse signal. The head drive circuit 101 may apply the second auxiliary pulse signal having a voltage that is close to 0 V and lower than the voltage of the expanded pulse. That is, the second auxiliary pulse signal may not cause the pressure chamber to be expanded as compared with the expansion pulse signal.

The ink jet head configured as described above applies an auxiliary pulse signal to the actuator 16 before applying the discharge pulse signal. For this reason, the inkjet head can generate pressure vibration in the pressure chamber before applying the discharge pulse signal.

When the ink jet head repeatedly applies the discharge pulse signal to the actuator 16, the ink droplet discharged by the second discharge pulse signal is stabilized by the influence of the pressure vibration generated by the first half discharge pulse signal.

The ink jet head in the example embodiments described above applies a discharge pulse signal in a state where the pressure vibration is generated. As a result, the ink jet head can stably discharge ink in low gradation printing.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An ink jet head comprising:
an actuator configured to cause ink to be discharged from a pressure chamber associated with the actuator; and
a control unit configured to apply to the actuator in a droplet ejection process:
an auxiliary signal that does not cause ink to be discharged from the pressure chamber, and
a discharge signal that causes ink to be discharged from the pressure chamber.

2. The ink jet head according to claim 1, wherein the auxiliary signal is a pulse signal having a pulse width equal to or less than ½ of a fundamental pressure oscillation period of the pressure chamber.

3. The ink jet head according to claim 1, wherein the auxiliary signal causes the pressure chamber to be contracted.

4. The ink jet head according to claim 1, wherein the auxiliary signal causes the pressure chamber to be expanded.

5. The ink jet head according to claim 1, wherein
the discharge signal comprises an expansion pulse signal and a pause during which the pressure chamber is permitted to return towards a relaxed state and
the discharge signal causes one ink droplet to be discharged from the pressure chamber per one cycle of the expansion pulse signal and the pause.

6. The ink jet head according to claim 1, wherein the control unit is further configured to apply to the actuator a cancel pulse signal that suppresses pressure vibration by at least one discharge pulse signal.

7. The ink jet head according to claim 1, wherein the ink jet head is a shared mode ink jet head.

8. An ink jet recording apparatus, comprising:
a transport unit that transports a recording medium;
an actuator configured to cause ink to be discharged from a pressure chamber associated with the actuator onto the recording medium; and
a control unit configured to apply to the actuator in a droplet ejection process:
an auxiliary signal that does not cause ink to be discharged from the pressure chamber, and
a discharge signal that causes ink to be discharged from the pressure chamber

9. The ink jet recording apparatus according to claim 8, wherein the auxiliary signal is a pulse signal having a pulse width equal to or less than ½ of a fundamental pressure oscillation period of the pressure chamber.

10. The ink jet recording apparatus according to claim 8, wherein the auxiliary signal causes the pressure chamber to be contracted.

11. The ink jet recording apparatus according to claim 8, wherein the auxiliary signal causes the pressure chamber to be expanded.

12. The ink jet recording apparatus according to claim 8, wherein
the discharge signal comprises an expansion pulse signal and a pause during which the pressure chamber is permitted to return towards a relaxed state and
the discharge signal causes one ink droplet to be discharged from the pressure chamber per one cycle of the expansion pulse signal and the pause.

13. The ink jet recording apparatus according to claim 8, wherein the control unit is further configured to apply to the actuator a cancel pulse signal that suppresses pressure vibration by at least one discharge pulse signal.

14. The ink jet recording apparatus according to claim 8, wherein the ink jet head is a shared mode ink jet head.

15. An ink jet head, comprising:
a first piezoelectric plate attached to an upper surface of a substrate;
a second piezoelectric plate attached to an upper surface of the first piezoelectric plate, wherein
the first and second piezoelectric plates have polarizations opposite to each other along a direction parallel to thicknesses of the first and second piezoelectric plates;
a chamber comprising:
a groove cut from an upper surface of the second piezoelectric plate toward a bottom surface of the first piezoelectric plate, shielded by a top plate at the upper surface of the second piezoelectric plate and by an orifice plate at a front edge of the groove;
an electrode on inner walls of the groove; and
a nozzle in the orifice plate at the front edge of the groove;
a pattern generator that generates an auxiliary signal and a discharge signal;
a drive circuit configured to receive the auxiliary signal and the discharge signal and drive the chamber, wherein
the auxiliary signal does not cause ink to be discharged from the pressure chamber, and
the discharge signal that causes ink to be discharged from the pressure chamber.

16. The ink jet head according to claim 15, wherein the auxiliary signal is a pulse signal having a pulse width equal to or less than ½ of a fundamental pressure oscillation period of the pressure chamber.

17. The ink jet head according to claim 15, wherein the auxiliary signal causes the pressure chamber to be contracted.

18. The ink jet head according to claim 15, wherein the auxiliary signal causes the pressure chamber to be expanded.

19. The ink jet head according to claim 15, wherein
the discharge signal comprises an expansion pulse signal and a pause during which the pressure chamber is permitted to return towards a relaxed state and
the discharge signal causes one ink droplet to be discharged from the pressure chamber per one cycle of the expansion pulse signal and the pause.

20. The ink jet head according to claim 15, wherein the control unit is further configured to apply to the actuator a cancel pulse signal that suppresses pressure vibration by at least one discharge pulse signal.
